(19) United States
(12) Patent Application Publication
(10) Pub. No.: US 2025/0002026 A1
(43) Pub. Date: Jan. 2, 2025

(54) ENERGY PREDICTION APPARATUS

(71) Applicant: DENSO CORPORATION, Kariya-city (JP)

(72) Inventor: Hiroyuki NANJO, Kariya-city (JP)

(73) Assignee: DENSO CORPORATION, Kariya-city (JP)

(21) Appl. No.: 18/751,391

(22) Filed: Jun. 24, 2024

(30) Foreign Application Priority Data
Jun. 27, 2023 (JP) 2023-104936

(51) Int. Cl. B60W 50/00

(52) U.S. Cl. CPC B60W 50/0097

(57) ABSTRACT

An energy prediction apparatus generates vehicle speed prediction information by predicting a vehicle speed variation state of a vehicle on an expected traveling route on which the vehicle is to travel; predicts required energy required by the vehicle when traveling the expected traveling route using the generated vehicle speed prediction information; and acquires variation information affecting the prediction of required energy. The energy prediction apparatus predicts the required energy based on the acquired variation information.

### CROSS-REFERENCE TO RELATED APPLICATIONS

This application is based on and claims the benefit of priority from Japanese Patent Application No. 2023-104936, filed on Jun. 27, 2023. The entire disclosure of the above application is incorporated herein by reference.

### BACKGROUND

### Technical Field

The present invention relates to an energy prediction apparatus.

### Related Art

Technologies for calculating and correcting energy consumption of an electric vehicle have been provided. In one technology, energy consumption of an electric vehicle is calculated based on a speed pattern and a gradient pattern. The calculated energy consumption is corrected using a correction parameter that is generated based on vehicle information.

### SUMMARY

An aspect of the present disclosure provides an energy prediction apparatus that: generates vehicle speed prediction information by predicting a vehicle speed variation state of a vehicle on an expected traveling route on which the vehicle is to travel; predicts required energy required by the vehicle when traveling the expected traveling route using the vehicle speed prediction information; and predicts the required energy based on variation information affecting the prediction of required energy.

### BRIEF DESCRIPTION OF THE DRAWINGS

In the accompanying drawings:

FIG. 1 is a block configuration diagram for explaining an energy prediction apparatus according to a present embodiment;

FIG. 2 is a flowchart for explaining an information processing flow using the energy prediction apparatus shown in FIG. 1;

FIG. 3 is a diagram illustrating an example of variation information related to weight;

FIG. 4 is a diagram illustrating an example of variation information related to rolling resistance;

FIG. 5 is a diagram illustrating an example of variation information related to vehicle speed;

FIG. 6 is a diagram illustrating an example of variation information related to acceleration;

FIG. 7 is a diagram for explaining energy estimation in an electric automobile;

FIG. 8 is a diagram illustrating an example of electrical system efficiency in energy estimation;

FIG. 9 is a diagram illustrating an example of engine efficiency in energy estimation in an engine automobile;

FIG. 10 is a diagram illustrating an example of engine efficiency in energy estimation;

FIG. 11 is a flowchart for explaining an information processing flow using the energy prediction apparatus shown in FIG. 1; and

FIG. 12 is a diagram illustrating an example of a relationship between influence factor and probability of occurrence.

### DESCRIPTION OF THE EMBODIMENTS

In JP 2016-049922 A, energy consumption of an electric vehicle is calculated based on a speed pattern and a gradient pattern. A correction parameter is generated based on vehicle information. Energy consumption is then corrected using the correction parameter.

As described in paragraph 0034 of JP 2016-049922 A, the correction parameter is estimated by energy consumption under specific conditions at an arbitrary location being actually measured and determined. Energy consumption is then corrected using the estimated correction parameter.

In JP 2016-049922 A, energy consumption reflecting an occurrence of external disturbance can be estimated. However, future variations in parameters affecting prediction of required energy required for vehicle travel cannot be taken into consideration.

It is thus desired to predict required energy required for vehicle travel while reflecting future variation factors affecting the required energy.

An exemplary embodiment of the present disclosure provides an energy prediction apparatus. The energy prediction apparatus generates vehicle speed prediction information by predicting a vehicle speed variation state of a vehicle on an expected traveling route on which the vehicle is to travel. The energy prediction apparatus predicts required energy required by the vehicle when traveling the expected traveling route using the vehicle speed prediction information. The energy prediction apparatus predicts the required energy while reflecting variation information affecting the prediction of required energy.

As a result of the exemplary embodiment of the present disclosure, required energy required for vehicle travel can be predicted with future variation factors affecting the required energy reflected in the prediction.

A present embodiment will hereinafter be described with reference to the accompanying drawings. To facilitate understanding of the descriptions, constituent elements that are identical are given the same reference numbers in the drawings when possible. Redundant descriptions are omitted.

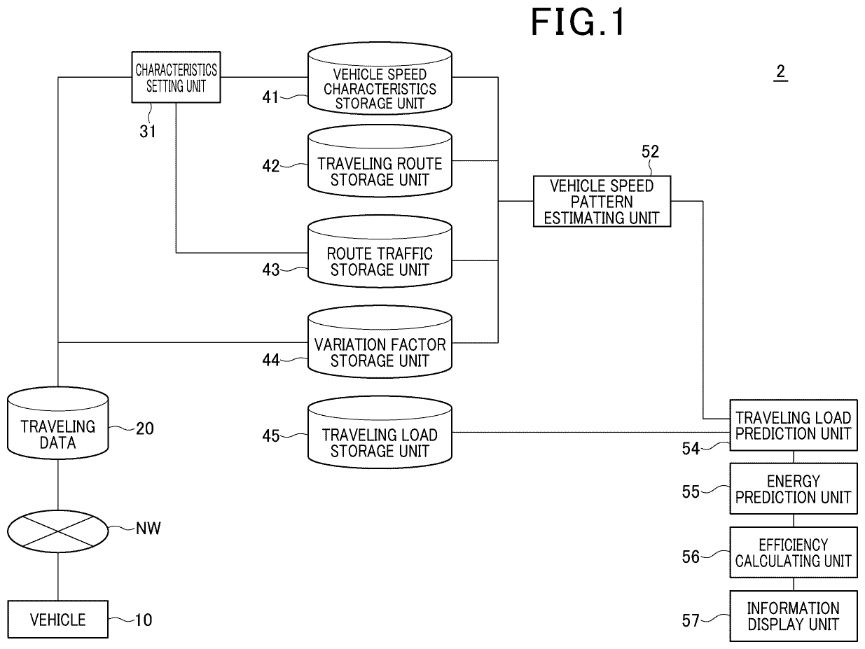

FIG. 1 is a diagram for explaining functional constituent elements of an energy prediction apparatus 2 according to the present embodiment. As shown in FIG. 1, the energy prediction apparatus 2 includes a traveling data storage unit 20, a characteristics setting unit 31, a vehicle speed characteristics storage unit 41, a traveling route storage unit 42, a route traffic storage unit 43, a variation factor storage unit 44, a traveling load storage unit 45, a vehicle speed pattern estimating unit 52, a traveling load prediction unit 54, an energy prediction unit 55, an efficiency calculating unit 56, and an information display unit 57. In terms of a hardware configuration, the energy prediction apparatus 2 is a computer system that includes a central processing unit (CPU), a memory, a communication interface, and the like.

A vehicle 10 is an example of a vehicle to be a target of prediction by the energy prediction apparatus 2 according to the present embodiment. The vehicle 10 is connected to a network NW. Traveling data of the vehicle 10 is transmitted to the traveling data storage unit 20 over the network NW. For purpose of illustration, only a single vehicle 10 is shown. However, the traveling data may be collected from numerous vehicles. In addition, the target of energy prediction may be numerous vehicles.

The traveling data storage unit 20 stores therein the traveling data transmitted from the vehicle 10. The traveling data includes information related to traveling, such as information related to acceleration and deceleration of the vehicle 10 and information related to traveling time. As the traveling data, information related to acceleration and deceleration of the vehicle 10 and information related to traveling time may be accumulated for each driver. In addition, as the traveling data, the information related to acceleration and deceleration of the vehicle 10 and the information related to traveling time may be accumulated in association with time information regarding the time at which a traveling state of the vehicle 10 occurs. Furthermore, as the traveling data, the information related to acceleration and deceleration of the vehicle 10 and the information related to traveling time may be accumulated in association with weather information regarding the weather when a traveling state of the vehicle 10 occurs.

The characteristics setting unit 31 sets vehicle speed basic characteristics of the vehicle 10 based on the traveling data stored in the traveling data storage unit 20. The vehicle speed basic characteristics include information related to acceleration and deceleration in a vehicle speed variation pattern. The vehicle speed basic characteristics also include traffic information regarding a route. The characteristics setting unit 31 stores the information related to acceleration and deceleration in the vehicle speed characteristics storage unit 41. The characteristics setting unit 31 stores the traffic information regarding the route in the route traffic storage unit 43.

The vehicle speed characteristics storage unit 41 stores therein the vehicle speed variation pattern as vehicle speed characteristics information. The vehicle speed characteristics information may be set for each vehicle type. Alternatively, the vehicle speed characteristics information may be set as information that is common among a plurality of vehicle types. For example, information that identifies a relationship between vehicle speed and acceleration may be stored as the vehicle speed variation pattern. In addition, for example, information that identifies a relationship between vehicle speed and deceleration may be stored as the vehicle speed variation pattern. The vehicle speed variation pattern stored in the vehicle speed characteristics storage unit 41 is not limited thereto. The acceleration or deceleration may be a fixed value. The vehicle speed characteristics information may be stored in advance. Alternatively, the vehicle speed characteristics information may be acquired from a server each time or set by a user.

The traveling route storage unit 42 stores therein route information regarding the traveling route on which the vehicle 10 travels until a timing at which control to estimate a cruising range is performed. Here, for example, the route information may include latitude information, longitude information, elevation information, and location classification information along a course from a current location to a destination on the traveling route on which the vehicle 10 is expected to travel. The latitude information indicates a latitude at a certain location. The longitude information indicates a longitude at a certain location. The elevation information indicates an elevation at a certain location.

The location classification information indicates a classification of a certain location. The classification of a location identifies an element that affects variations in vehicle speed of the vehicle. For example, a classification type “0” may indicate “travel-through”. A classification type “1” may indicate a “vehicle-stopping point: traffic light”. A classification type “2” may indicate a “vehicle-stopping point: bus stop”. A classification type “3” may indicate a “temporary stop location”. A classification type “4” may indicate a “left/right turn location, no traffic light”.

The route traffic storage unit 43 stores therein the traffic information regarding the traveling route on which the vehicle 10 travels until a timing at which estimation of the cruising range is performed. Here, for example, the traffic information may indicate congestion information, construction information, accident information, and traveling conditions that affect a traveling speed of the vehicle such as presence/absence of intersections and traffic lights, regarding the traveling route. The traffic information may also include information on legal speed limits.

The variation factor storage unit 44 stores therein variation information that affects prediction of required energy required by the vehicle when traveling on an expected traveling route. The variation information includes information that identifies an influence factor affecting the prediction of required energy and a probability of occurrence thereof. The variation information includes information that identifies the influence factor affecting the prediction of required energy and a variation range thereof. The variation range may be identified by a maximum value and a minimum value of the influence factor. The variation range may be identified by a maximum value and a minimum value of a range in which the probability of occurrence of the influence factor exceeds a threshold. The variation information will be explained in detail hereafter.

The traveling load storage unit 45 stores therein traveling load information that is required for estimation of a traveling load. The traveling load is calculated using acceleration resistance, air resistance, gradient resistance, and rolling resistance. Therefore, information on the acceleration resistance, the air resistance, the gradient resistance, and the rolling resistance is stored as the traveling load information.

The vehicle speed characteristics storage unit 41, the traveling route storage unit 42, the route traffic storage unit 43, the variation factor storage unit 44, and the traveling load storage unit 45 may be provided in physically differing memory apparatuses. Alternatively, for example, the vehicle speed characteristics storage unit 41, the traveling route storage unit 42, the route traffic storage unit 43, the variation factor storage unit 44, and the traveling load storage unit 45 may be provided such as to be integrated in a single memory apparatus.

The vehicle speed pattern estimating unit 52 estimates a pattern of a relationship between distance and vehicle speed based on vehicle speed probability and an acceleration/deceleration pattern. When a specific target driver is selected, the vehicle speed pattern estimating unit 52 estimates the pattern of the relationship between the distance and the vehicle speed that is adapted to the target driver. The vehicle speed pattern estimating unit 52 estimates a pattern of a relationship between the vehicle speed and time by taking into consideration an amount of time over which the vehicle speed is maintained in the pattern of the relationship between the distance and the vehicle speed.

The traveling load prediction unit 54 predicts the traveling load based on the pattern of the relationship between the distance and the vehicle speed estimated by the vehicle speed pattern estimating unit 52 and the traveling load information stored in the traveling load storage unit 45. The energy prediction unit 55 predicts required energy required for traveling based on the traveling load predicted by the traveling load prediction unit 54.

The efficiency calculating unit 56 calculates efficiency, such as electricity consumption and fuel consumption, based on the required energy predicted by the energy prediction unit 55 and a traveling distance. The traveling distance may be determined by time integration of the vehicle speed variation patterns estimated by the vehicle speed pattern estimating unit 52. Alternatively, the traveling distance may be determined by integration of distances between locations identified by the latitude information and the longitude information. The information display unit 57 notifies the user of the efficiency calculated by the efficiency calculating unit 56.

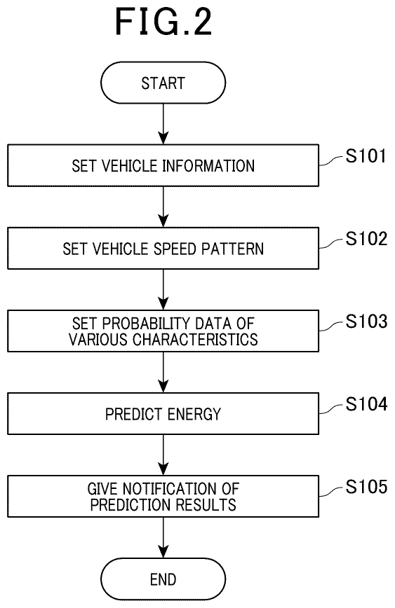

Next, an information processing flow using the energy prediction apparatus 2 will be described with reference to FIG. 2. At step S101, the traveling load prediction unit 54 sets vehicle information. The vehicle information is information used to calculate the required energy. The vehicle information includes a vehicle gross weight, an air resistance coefficient, a frontal projected area, and the like. The traveling load prediction unit 54 acquires the vehicle information from the information stored in the traveling load storage unit 45.

At step S102 following step S101, the vehicle speed pattern estimating unit 52 sets the vehicle speed variation pattern. Various methods can be used to set the vehicle speed variation pattern. The vehicle speed pattern estimating unit 52 can set the vehicle speed variation pattern by acquiring information related to acceleration and deceleration. The vehicle speed pattern estimating unit 52 acquires the information related to acceleration and deceleration from the information stored in the vehicle speed characteristics storage unit 41.

The vehicle speed pattern estimating unit 52 can also set a vehicle speed variation pattern to be newly used by selecting the vehicle speed variation pattern from the vehicle speed variation patterns accumulated in the past. The vehicle speed pattern estimating unit 52 can also set a vehicle speed variation pattern to be newly used by combining a plurality of vehicle speed variation patterns accumulated in the past. The past vehicle speed variation patterns are accumulated in the vehicle speed characteristics storage unit 41.

At step S103 following step S102, the vehicle speed pattern estimating unit 52 sets probability data of various characteristics. The probability data of various characteristics is set based on the information stored in the vehicle speed characteristics storage unit 41 and the variation factor storage unit 44.

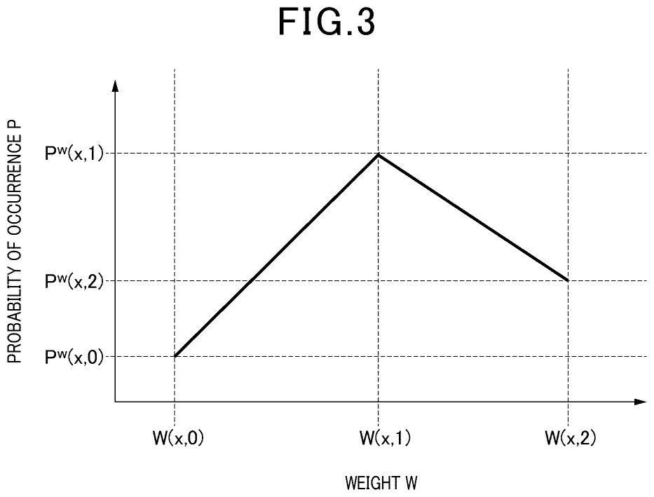

FIG. 3 is a diagram of an example of a vehicle weight and the probability of occurrence thereof at each location. In the example in FIG. 3, a weight W(x,i) and a probability of occurrence P^{W}(x,i) at a location x are accumulated in association. The variation information associating the vehicle weight and the probability of occurrence thereof at each location is stored in the variation factor storage unit 44. The weight and the probability of occurrence at each location can be set by, for example, data being accumulated on a number of passengers at each location on a fixed-route bus or the like and weight per person being set to 60 kg.

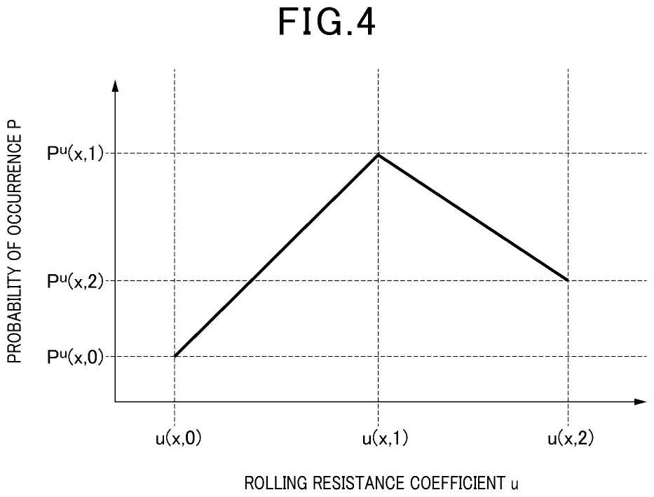

FIG. 4 is a diagram of an example of a rolling resistance coefficient and the probability of occurrence thereof at each location. In the example in FIG. 4, a rolling resistance coefficient u(x,i) and a probability of occurrence P^{u}(x,i) at a location x are accumulated in association. The variation information associating the rolling resistance coefficient and the probability of occurrence thereof at each location is stored in the variation factor storage unit 44. For example, data on the rolling resistance coefficient u calculated in the past can be accumulated. The rolling resistance coefficient u may be set in advance based on a road surface state. The road surface state includes a road material, a road surface shape, a snowfall state, a freezing state, and the like.

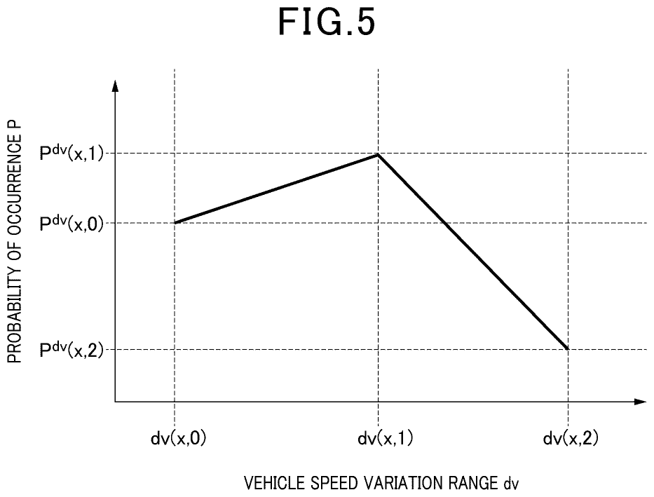

FIG. 5 is a diagram of an example of a vehicle speed variation range and the probability of occurrence thereof at each location. In the example in FIG. 5, a vehicle speed variation range dv(x,i) and a probability of occurrence P^{dv}(x,i) at a location x are accumulated in association. The variation information associating the vehicle speed variation range and the probability of occurrence thereof at each location is stored in the variation factor storage unit 44. The variation information can be generated from data on the vehicle speed patterns stored in the vehicle speed characteristics storage unit 41. The variation information may be stored in the vehicle speed characteristics storage unit 41. Here, the variation information may be the vehicle speed itself rather than the vehicle speed variation range.

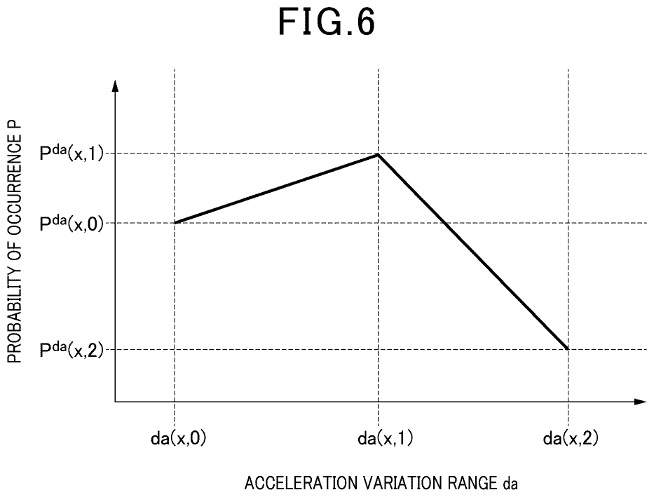

FIG. 6 is a diagram of an example of an acceleration variation range and the probability of occurrence thereof at each location. In the example in FIG. 6, an acceleration variation range da(x,i) and a probability of occurrence P^{da}(x,i) at a location x are accumulated in association. The variation information associating the acceleration variation range and the probability of occurrence thereof at each location is stored in the variation factor storage unit 44. The variation information can be generated from data on the vehicle speed patterns stored in the vehicle speed characteristics storage unit 41. The variation information may be stored in the vehicle speed characteristics storage unit 41. Here, the variation information may be the acceleration itself rather than the acceleration variation range.

The description will be continued with reference to FIG. 2 again. At step S104 following step S103, the traveling load prediction unit 54 and the energy prediction unit 55 predict the required energy.

The traveling load prediction unit 54 predicts the traveling load from the vehicle speed variation pattern. The traveling load is determined as a sum of the acceleration resistance, the air resistance, the gradient resistance, and the rolling resistance. A traveling load F_{drv}(t) is predicted using a following expression (f10).

$${F}_{drv} ( t ) = ( Σ {P}^{W} ( x , i ) * W ( x , i ) ) * ( Σ {P}^{da} ( x , i ) * ( a ( t ) + da ( x , i ) ) ) + 0.5 * ρ * Cd * A ( Σ {P}^{dv} ( x , i ) * {( v ( t ) + dv ( x , i ) )}^{2} ) + ( Σ {P}^{u} ( x , i ) * u ( x , i ) ) ( Σ {P}^{W} ( x , i ) * W ( x , i ) ) g + ( Σ {P}^{W} ( x , i ) * W ( x , i ) ) g sin θ ( t ) \qquad ( f01 )$$

t: time
a(t): acceleration at time t
ρ: air density
A: frontal projected area
v(t): speed at time t
g: gravitational acceleration
θ(t): gradient between location at time t and location at time t−1

The air density ρ may be a fixed value of 1.293 kg/m³. The air density ρ may be calculated from air temperature. The gravitational acceleration g may be a fixed value of 9.8 m/s². The gradient θ(t) can be determined from the latitude and longitude information and the elevation information in the traveling route information as shown in the example in FIG. 6.

The traveling load prediction unit 54 predicts a traveling horsepower P_{drv}(t) using a following expression (f02).

$${P}_{drv} ( t ) = {F}_{drv} ( t ) * Σ {P}_{dv} ( x , i ) * ( v ( t ) + dv ( x , i ) ) \qquad ( f02 )$$

The energy prediction unit 55 calculates drive system efficiency. The energy prediction unit 55 estimates a required energy amount.

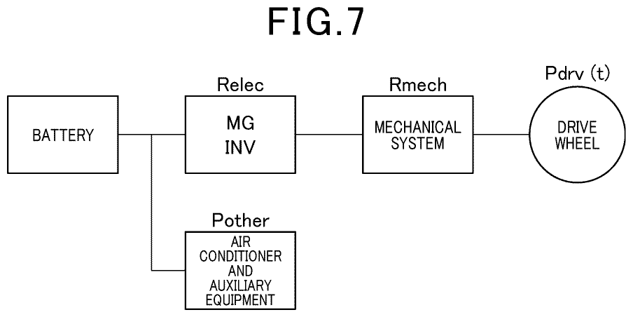

FIG. 7 shows an example of a system in a case of an electric automobile. In the system shown in the example in FIG. 7, system efficiency of an electrical system (MG-INV) is R_{elec} and efficiency of a mechanical system is R_{mech}. A fixed value of 70% can be used as the efficiency R_{mech} of the mechanical system. The efficiency R_{mech} of the mechanical system indicates that energy that is inputted to the mechanical system is transmitted to a drive wheel at the efficiency R_{mech}, and the traveling horsepower P_{drv}(t) is generated. Therefore, energy P′_{drv}(t) that is inputted to the mechanical system can be calculated by a following expression (f03).

$${P}_{drv}^{′} ( t ) = {P}_{drv} ( t ) / {R}_{mech} \qquad ( f03 )$$

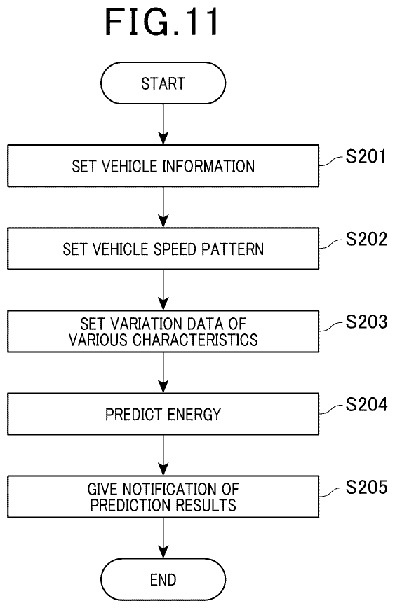

The efficiency R_{elec} of the electrical system is prescribed as shown in an example in FIG. 11, for example, by a function with energy that is inputted from the electrical system to the mechanical system.

Energy P″_{drv}(t) for traveling that is supplied to the electrical system can be calculated by a following expression (f04).

$${P}_{drv}^{″} ( t ) = {P}_{drv}^{′} ( t ) / {R}_{elec} ( {P}_{drv}^{′} ( t ) ) \qquad ( f04 )$$

When the energy expressed by expression (f04) is integrated until time t, a traveling energy E_{drv_prd_base} is as expressed in a following expression (f05).

$${E}_{drv\_prd \_base} = Σ ( {P}_{drv}^{″} ( t ) * ( t - ( t - 1 ) ) \qquad ( f05 )$$

When E_{drv_prd_base}<0, energy is stored in a battery as regenerative energy.

The energy that is required for driving an air conditioner and auxiliary equipment is Pₒₜₕₑᵣ(t). Pₒₜₕₑᵣ(t) may be a fixed value of 5 kW. When Pₒₜₕₑᵣ(t) is integrated until time t, an auxiliary equipment energy E_{other_prd_base} is expressed as in a following expression (f06).

$${E}_{other\_prd \_base} = Σ ( {P}_{other} ( t ) * ( t - ( t - 1 ) ) \qquad ( f06 )$$

From expression (f05) and expression (f06), a required energy amount E_{total_prd_base} is expressed as in a following expression (f07).

$${E}_{total\_prd \_base} ( t ) = {E}_{drv\_prd \_base} ( t ) + {E}_{other\_prd \_base} ( t ) \qquad ( f07 )$$

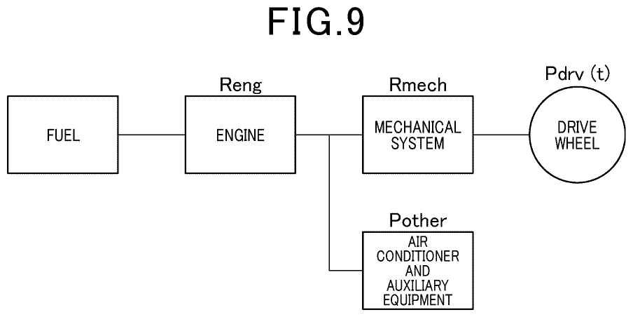

The present embodiment can also be applied to an engine automobile, in addition to the electric automobile. FIG. 9 shows an example of a system in a case of an engine automobile. In the system shown in the example in FIG. 9, engine efficiency is R_{eng}. The efficiency of the mechanical system is R_{mech}. A fixed value of 70% can be used as the efficiency R_{mech} of the mechanical system. The efficiency R_{mech} of the mechanical system indicates that energy that is inputted to the mechanical system is transmitted to the drive wheel at the efficiency R_{mech}, and the traveling horsepower P_{drv}(t) is generated. Therefore, energy P′_{drv}(t) that is inputted to the mechanical system can be calculated by a following expression (f08).

$${P}_{drv}^{′} ( t ) = {P}_{drv} ( t ) / {R}_{mech} \qquad ( f08 )$$

In addition to the energy for traveling, energy for driving the air conditioner and auxiliary equipment is also supplied from the engine. The energy that is required for driving the air conditioner and auxiliary equipment is Pₒₜₕₑᵣ(t). Pₒₜₕₑᵣ(t) may be a fixed value of 5 kW.

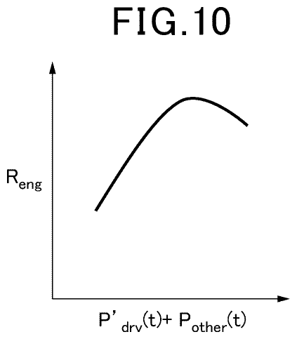

The engine efficiency R_{eng} is a function of the energy that is inputted to the mechanical system from the engine and the energy for driving auxiliary equipment. For example, the engine efficiency R_{eng} may be prescribed as shown in the example in FIG. 10.

A total energy amount Pₛᵤₘ(t) is predicted by following expressions (f09) and (f10).

$${P}_{sum} ( t ) = {P}_{drv}^{′} ( t ) + {P}_{other} ( t ) \qquad ( f09 )$$

$${P}_{sum}^{′} ( t ) = {P}_{sum} ( t ) / {R}_{eng} ( {P}_{sum} ( t ) ) \qquad ( f10 )$$

Because the engine automobile does not store regenerative energy, only a positive numeric value is applicable.

$${P}_{sum}^{″} ( t ) = {P}_{sum}^{′} ( t ) ( {P}_{sum}^{′} ( t ) > 0 ) \qquad ( f11 )$$

When the energy expressed by expression (f11) is integrated until time t, the required energy amount E_{total_prd_base} is expressed as in a following expression (f12).

$${E}_{total\_prd \_base} ( t ) = Σ ( {P}_{sum}^{″} ( t ) * ( t - ( t - 1 ) ) \qquad ( f12 )$$

Here, traveling energy and other energies are predicted in the following manner.

$${E}_{drv\_prd \_base} ( t ) = {E}_{total\_prd \_base} ( t ) * ( {P}_{drv}^{′} ( t ) / {P}_{sum}^{′} ( t ) ) \qquad ( f13 )$$

$${E}_{other\_prd \_base} ( t ) = {E}_{total\_prd \_base} ( t ) - {E}_{drv\_prd \_base} ( t ) \qquad ( f14 )$$

At step S105 following step S104, the information display unit 57 notifies the user of information related to the energy prediction results. A mode of notification is not particularly limited. The user can be notified through use of an application or the like.

Next, another example of the information processing flow using the energy prediction apparatus 2 will be described with reference to FIG. 11. At step S201, the traveling load prediction unit 54 sets the vehicle information. The setting of the vehicle information by the traveling load prediction unit 54 is similar to the process at step S101 described with reference to FIG. 2. Therefore, description thereof is omitted.

At step S202 following step S201, the vehicle speed pattern estimating unit 52 sets the vehicle speed variation pattern. The setting of the vehicle speed variation pattern by the vehicle speed pattern estimating unit 54 is similar to the process at step S102 described with reference to FIG. 2. Therefore, description thereof is omitted.

At step S203 following step S202, the vehicle speed pattern estimating unit 52 sets variation data of various characteristics. The variation data of various characteristics is set based on the information stored in the vehicle speed characteristics storage unit 41 and the variation factor storage unit 44. The variation data of various characteristics is a variation amount of a numeric value of a parameter used to calculate energy. The variation data of various characteristics may be, for example, a maximum value and a minimum value of a parameter used to calculate energy.

For example, the variation factor storage unit 44 accumulates a maximum value W_max(x) and a minimum value W_min(x) of the weight at location x. The minimum value and the maximum value of the weight at each location can be set by, for example, data being accumulated on the number of passengers at each location on a fixed-route bus or the like and the weight per person being set to 60 kg.

For example, the variation factor storage unit 44 may accumulate a minimum value u_min(x) and a maximum value u_max(x) of the rolling resistance coefficient at location x. For example, data on the rolling resistance coefficient u calculated in the past can be accumulated. The rolling resistance coefficient u may be set in advance based on the road surface state. The road surface state includes the road material, the road surface shape, the snowfall state, the freezing state, and the like.

For example, the variation factor storage unit 44 may accumulate a minimum value dv_min(x) and a maximum value dv_max(x) of the vehicle speed variation at location x. The variation information can be generated from data on the vehicle speed patterns stored in the vehicle speed characteristics storage unit 41. The minimum value dv_min(x) and the maximum value dv_max(x) of the vehicle speed variation may be stored in the vehicle speed characteristics storage unit 41. Here, the variation information may be the vehicle speed itself rather than the vehicle speed variation range.

For example, the variation factor storage unit 44 may accumulate a minimum value da_min(x) and a maximum value da_max(x) of the acceleration variation at location x. The variation information can be generated from data on the vehicle speed patterns stored in the vehicle speed characteristics storage unit 41. The variation information may be stored in the vehicle speed characteristics storage unit 41. Here, the variation information may be the acceleration itself rather than the acceleration variation range.

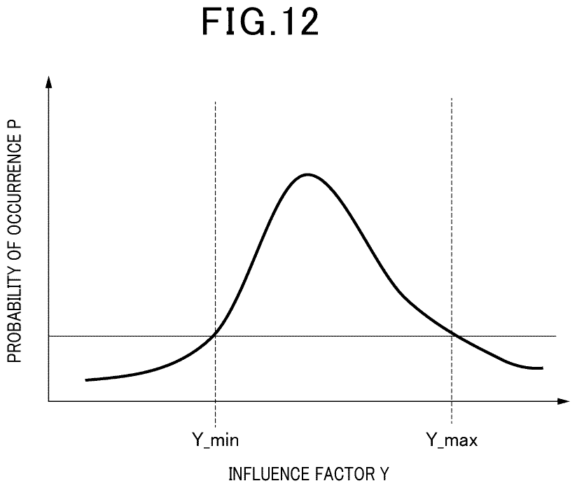

Here, the minimum value and the maximum value of the variation data such as the weight, the rolling resistance, the vehicle speed, and the acceleration may be the minimum value and the maximum value when the probability of occurrence is equal to or greater than a predetermined probability of occurrence. As shown in an example in FIG. 12, regarding an influence factor Y, a minimum value Y_min and a maximum value Y_max may be that at which a probability of occurrence P is equal to or greater than a predetermined value.

At step S204 following step S203, the traveling load prediction unit 54 and the energy prediction unit 55 predict the required energy.

The traveling load prediction unit 54 predicts the traveling load from the vehicle speed variation pattern. The traveling load is determined as the sum of the acceleration resistance, the air resistance, the gradient resistance, and the rolling resistance. A traveling load F_{drv_min}(t) serving as a minimum value and a traveling load F_{drv_max}(t) serving as a maximum value are predicted using following expressions (f21) and (f22).

$${F}_{drv\_min} ( t ) = W\_min ( x ) * ( a ( t ) + da\_min ( x ) ) + 0.5 * ρ * Cd * A * {( v ( t ) + dv\_min ( x ) )}^{2} + u\_min ( x ) * W\_min ( x ) g + W\_min ( x ) * g sin θ ( t ) \qquad ( f21 )$$

$${F}_{drv\_max} ( t ) = W\_max ( x ) * ( a ( t ) + da\_max ( x ) ) + 0.5 * ρ * Cd * A * {( v ( t ) + dv\_max ( x ) )}^{2} + u\_max ( x ) * W\_max ( x ) g + W\_max ( x ) * g sin θ ( t ) \qquad ( f22 )$$

t: time
a(t): acceleration at time t
ρ: air density
A: frontal projected area
v(t): speed at time t
g: gravitational acceleration
θ(t): gradient between location at time t and location at time t−1

The air density ρ may be a fixed value of 1.293 kg/m³. The air density ρ may be calculated from air temperature. The gravitational acceleration g may be a fixed value of 9.8 m/s². The gradient θ(t) can be determined from the latitude and longitude information and the elevation information in the traveling route information as shown in the example in FIG. 6.

The traveling load prediction unit 54 predicts a traveling horsepower P_{drv_min}(t) serving as a minimum value and a traveling horsepower P_{drv_max}(t) serving as a maximum value using following expressions (f23) and (f24).

$${P}_{drv\_min} ( t ) = {F}_{drv\_min} ( t ) * ( v ( t ) + dv\_min ( x ) ) \qquad ( f23 )$$

$${P}_{drv\_max} ( t ) = {F}_{drv\_max} ( t ) * ( v ( t ) + dv\_max ( x ) ) \qquad ( f24 )$$

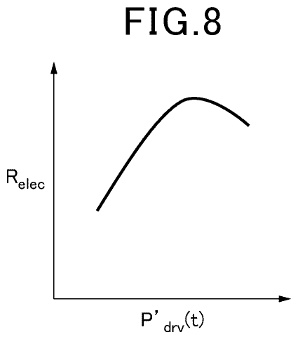

The energy prediction unit 55 calculates the drive system efficiency. The energy prediction unit 55 calculates a minimum value and a maximum value of the required energy amount as the variation range of the required energy amount. Calculation of an energy prediction value using the traveling load and the traveling horsepower is similar to calculations described with reference to FIGS. 7, 8, 9, and 10. Therefore, description thereof is omitted.

At step S205 following step S204, the information display unit 57 notifies the user of information related to the energy prediction results. The mode of notification is not particularly limited. The user can be notified through use of an application or the like.

### ADDITIONAL NOTES

Additional notes 1 to 7 described below can be arbitrarily combined as long as technical inconsistencies do not occur.

### Additional Note 1

An energy prediction apparatus including: a generating unit that generates vehicle speed prediction information by predicting a vehicle speed variation state of a vehicle on an expected traveling route on which the vehicle is to travel; a prediction unit that predicts required energy required by the vehicle when traveling the expected traveling route using the vehicle speed prediction information; and an acquisition unit that acquires variation information affecting the prediction of required energy, in which the prediction unit predicts the required energy while reflecting the variation information.

The generating unit in additional note 1 corresponds to the vehicle speed pattern estimating unit 52 according to the present embodiment. The prediction unit in additional note 1 corresponds to the traveling load prediction unit 54 and the energy prediction unit 55 according to the present embodiment. The acquisition unit in additional note 1 corresponds to the vehicle speed characteristics storage unit 41 and the variation factor storage unit 44 according to the present embodiment. The variation information is merely required to be in a usable state when the prediction unit predicts the required energy and may be acquired through a means of some sort by any of the vehicle speed pattern estimating unit 52, the traveling load prediction unit 54, and the energy prediction unit 55, without being acquired through the vehicle speed characteristics storage unit 41 and the variation factor storage unit 44.

As a result of additional note 1, the required energy is predicted with the variation information affecting the prediction of required energy reflected in the prediction. Therefore, the prediction of required energy can be performed based on various states.

### Additional Note 2

The energy prediction apparatus described in additional note 1, in which: the variation information includes information identifying an influence factor affecting the prediction of required energy and a probability of occurrence thereof; and the prediction unit predicts the required energy as an expected value of energy based on the probability of occurrence of the influence factor.

As a result of additional note 2, the required energy can be predicted as an expected value. The prediction of required energy can be performed based on various states.

### Additional Note 3

The energy prediction apparatus described in additional note 1, in which: the variation information includes information identifying an influence factor affecting the prediction of required energy and a variation range thereof; and the prediction unit predicts the required energy as a prediction value of energy based on the variation range of the influence factor.

As a result of additional note 3, the required energy can be predicted as a prediction value based on the variation range. The prediction of required energy can be performed based on various states.

### Additional Note 4

The energy prediction apparatus described in additional note 3, in which the variation range is identified by a maximum value and a minimum value of the influence factor.

### Additional Note 5

The energy prediction apparatus described in additional note 3, in which the variation range is identified by a maximum value and a minimum value of a range in which a probability of occurrence of the influence factor exceeds a threshold.

### Additional Note 6

An energy prediction apparatus including: a processor; a non-transitory computer-readable storage medium; and a set of computer-executable instructions stored on the computer-readable storage medium that, when read and executed by the processor, cause the processor to implement: generating vehicle speed prediction information by predicting a vehicle speed variation state of a vehicle on an expected traveling route on which the vehicle is to travel; predicting required energy required by the vehicle when traveling the expected traveling route using the vehicle speed prediction information; and acquiring variation information affecting the prediction of required energy, wherein predicting the required energy includes predicting the required energy while reflecting the variation information.

As a result of additional note 6, the required energy is predicted with the variation information affecting the prediction of required energy reflected in the prediction. Therefore, the prediction of required energy can be performed based on various states.

### Additional Note 7

An energy prediction method including: generating vehicle speed prediction information by predicting a vehicle speed variation state of a vehicle on an expected traveling route on which the vehicle is to travel; predicting required energy required by the vehicle when traveling the expected traveling route using the vehicle speed prediction information; and acquiring variation information affecting the prediction of required energy, wherein predicting the required energy includes predicting the required energy while reflecting the variation information.

As a result of additional note 7, the required energy is predicted with the variation information affecting the prediction of required energy reflected in the prediction. Therefore, the prediction of required energy can be performed based on various states.

The control unit and the method thereof described in the present disclosure may be actualized by a dedicated computer that is provided such as to be configured by a processor and a memory, the processor being programmed to provide one or a plurality of functions that are realized by a computer program. Alternatively, the control unit and the method thereof described in the present disclosure may be actualized by a dedicated computer that is provided by a processor being configured by a single dedicated hardware logic circuit or more. Still alternatively, the control unit and the method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible, computer-readable storage medium that can be read by a computer as instructions performed by the computer.

The present embodiment is described above with reference to specific examples. However, the present invention is not limited to these specific examples. Design modifications to the above-described specific examples made as appropriate by a person skilled in the art are included in the scope of the present invention as long as features of the present included are included. Elements included in the above-described specific examples, as well as arrangements, conditions, shapes, and the like thereof are not limited to those given as examples and can be modified as appropriate. Combinations of elements included in the above-described specific examples can be changed as appropriate as long as technical inconsistencies do not occur.

What is claimed is:

1. An energy prediction apparatus comprising:
a generating unit that generates vehicle speed prediction information by predicting a vehicle speed variation state of a vehicle on an expected traveling route on which the vehicle is to travel;
a prediction unit that predicts required energy required by the vehicle when traveling the expected traveling route using the vehicle speed prediction information; and
an acquisition unit that acquires variation information affecting the prediction of required energy, wherein
the prediction unit predicts the required energy based on the variation information.

2. The energy prediction apparatus according to claim 1, wherein:
the variation information includes information identifying an influence factor affecting the prediction of required energy and a probability of occurrence thereof, and
the prediction unit predicts the required energy as an expected value of energy based on the probability of occurrence of the influence factor.

3. The energy prediction apparatus according to claim 1, wherein:
the variation information includes information identifying an influence factor affecting the prediction of required energy and a variation range thereof; and
the prediction unit predicts the required energy as a prediction value of energy based on the variation range of the influence factor.

4. The energy prediction apparatus according to claim 3, wherein:
the variation range is identified by a maximum value and a minimum value of the influence factor.

5. The energy prediction apparatus according to claim 3, wherein:
the variation range is identified by a maximum value and a minimum value of a range in which a probability of occurrence of the influence factor exceeds a threshold.

6. An energy prediction apparatus comprising:
a processor;
a non-transitory computer-readable storage medium; and
a set of computer-executable instructions stored on the computer-readable storage medium that, when read and executed by the processor, cause the processor to implement:
generating vehicle speed prediction information by predicting a vehicle speed variation state of a vehicle on an expected traveling route on which the vehicle is to travel;
predicting required energy required by the vehicle when traveling the expected traveling route using the vehicle speed prediction information; and
acquiring variation information affecting the prediction of required energy, wherein
predicting the required energy comprises predicting the required energy based on the variation information.

7. An energy prediction method comprising:
generating vehicle speed prediction information by predicting a vehicle speed variation state of a vehicle on an expected traveling route on which the vehicle is to travel;
predicting required energy required by the vehicle when traveling the expected traveling route using the vehicle speed prediction information; and
acquiring variation information affecting the prediction of required energy, wherein
predicting the required energy comprises predicting the required energy based on the variation information.
